(19) United States
(12) Patent Application Publication
(10) Pub. No.: US 2024/0168756 A1
(43) Pub. Date: May 23, 2024

(54) UPDATING SOFTWARE CODE IN A CODE MANAGEMENT SYSTEM

(71) Applicant: BRITISH TELECOMMUNICATIONS PUBLIC LIMITED COMPANY, London (GB)

(72) Inventors: Johannes NOPPEN, London (GB); Aftab ALI, London (GB); Mamun ABU-TAIR, London (GB); Sally MCCLEAN, London (GB); Adam ZIOLKOWSKI, London (GB); Alistair MCCORMICK, London (GB); Naveed KHAN, London (GB)

(21) Appl. No.: 18/551,475

(22) PCT Filed: Mar. 10, 2022
(86) PCT No.: PCT/EP2022/056224

§ 371 Date: Sep. 20, 2023

(30) Foreign Application Priority Data
Mar. 22, 2021 (GB) 2103915.1

(51) Int. Cl. G06F 8/71; G06F 8/65; G06F 8/77

(52) U.S. Cl. CPC G06F 8/71; G06F 8/65; G06F 8/77

(57) ABSTRACT

A computer implemented method of updating software code in a code management system, the method including receiving candidate code for merging with the code in the code management system; extracting each of a plurality of features of the candidate code, each feature being based on one or more predetermined metrics of the candidate code; processing at least a subset of the extracted features by each of a plurality of disparate classifiers, each classifier being trained by a supervised training method to identify one or more software code defects, such that each classifier identifies a set of features as indicative of a software code defect, wherein intersections between a predetermined number of the sets of features identified by the classifiers are indicated as prospective code defects; selectively merging the candidate code with the code in the code management system based on the prospective code defects.

### PRIORITY CLAIM

The present application is a National Phase entry of PCT Application No. PCT/EP2022/056224, filed Mar. 10, 2022, which claims priority from GB Patent Application No. 2103915.1, filed Mar. 22, 2021, each of which is hereby fully incorporated herein by reference.

### TECHNICAL FIELD

The present disclosure relates to the management of software code and, in particular, to the updating of software code in a code management system.

### BACKGROUND

Software development or generation is increasingly a progressive task involving the generation of multiple versions of software over time. The management of code such as source code, scripts, makefiles, build scripts, metadata, resource files, specifications, configuration files, media and the like, requires a version-controlled code management system. Utilizing such a system, versions of a software component such as an application, product or the like, can be generated based on a determined state of the software code.

Changes to software code can be made by software engineers, automated software generators, automated coding or artificial intelligence. Such changes can include addition, deletion or modification to code within the version-controlled code management system.

Performance of software depends on the suitability, accuracy, efficiency and correctness of the code constituting the software. Performance can include, for example, a degree of efficacy of software, an error rate, an efficiency of software (in terms of, e.g., inter alia, speed of execution and/or efficiency of computer resource usage), and other performance measures as will be apparent to those skilled in the art.

The code development process involves the development of new or amended code as candidate code for merging with existing code in a code management system. Such merger is thus the inclusion of the new or amended code in the code management system. The new or amended code can include defects affecting the performance of software and it is desirable to provide for the detection of defects in software code proposed for inclusion in a code management system.

### SUMMARY

According to a first aspect of the present disclosure, there is provided a computer implemented method of updating software code in a code management system, the method comprising: receiving candidate code for merging with the code in the code management system; extracting each of a plurality of features of the candidate code, each feature being based on one or more predetermined metrics of the candidate code; processing at least a subset of the extracted features by each of a plurality of disparate classifiers, each classifier being trained by a supervised training method to identify one or more software code defects, such that each classifier identifies a set of features as indicative of a software code defect, wherein intersections between a predetermined number of the sets of features identified by the classifiers are indicated as prospective code defects; selectively merging the candidate code with the code in the code management system based on the prospective code defects.

In some embodiments, the predetermined number of sets is one of: a proportion of the number of disparate classifiers used to process the extracted features; at least two; and a predetermined threshold number of sets.

In some embodiments, the method further comprises applying a clustering method to the prospective code defects based on features of each prospective code defect to divide the prospective code defects into clusters, such that each cluster constitutes a type of code defect, and wherein selectively merging the candidate code with the code in the code management system is based on the types of code defect indicated by the clusters.

In some embodiments, the features of each prospective code defect includes one or more of: attributes of the prospective code defect determined by one or more of the classifiers; and one or more features of the candidate code on which basis the prospective code defect was identified by the classifiers.

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of a defect identification system in accordance with embodiments of the present disclosure.

FIG. 3 is a flowchart of a method of updating software code in a code management system in accordance with embodiments of the present disclosure.

### DETAILED DESCRIPTION

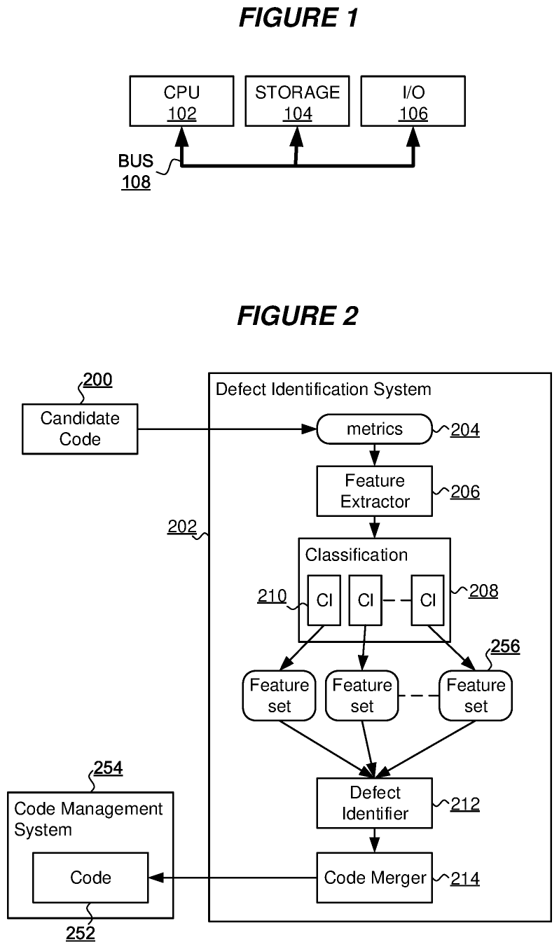

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of a defect identification system in accordance with embodiments of the present disclosure. A code management system 254 is provided such as a code repository or the like as will be apparent to those skilled in the art. The code management system 254 stores code 252 as software code for building into one or more software components, applications and/or products. Code in development is prepared by programmers or automated code generation systems and is provided as candidate code 200 as a candidate for merging with the code 252 in the code management system 254. Merging of code can include one or more of addition, modification or deletion or code in the code management system 252. Merging of code can also include additions, modifications or deletions to code in individual code components in the code 252 such as source code files, modules, libraries, classes, functions or the like.

The defect identification system 202 is a hardware, software, firmware or combination component arranged to detect code defects in candidate code 200 for merging with the code 252 in the code management system, and to selectively merge the candidate code 200. The selectivity of the merger is based on the detection of code defects by the defect identification system 202. A defect in the candidate code 200 can include one or more of: logical or functional errors such that the code does not provide logic or function in accordance with a requirement or specification; performance defects such that the code does not perform in accordance with one or more performance requirements of the code; security defects such that the code does not satisfy requisite security requirements; usability defects such that the code cannot be or is less susceptible to effective use; compatibility defects such that the code is incompatible with one or more requirements such as application programming interfaces (APIs), file formats, communications protocols, or the like; programming errors such as the use of incorrect or non-existent code; and other defects as will be apparent to those skilled in the art.

The defect identification system 202 is provided as a composite component including a plurality of other components as will be described below. It will be appreciated by those skilled in the art that the defect identification system 202 could alternatively be provided as a plurality of separate components each providing some subset of the functions of the overall defect identification system. The defect identification system 202 accesses the candidate code 200 to received, generate or determine metrics 204 of the candidate code 200. Such metrics can include, inter alia, by way of example: cyclometric complexity; fan-in; fan-out; lines of code; lines of code per method, function, procedure, subroutine and/or component; size of the candidate code and/or any of its constituent parts; relationships used by or with the code including inheritance relationships such as depth of inheritance including a number of different classes that inherit from one another back to a base class; a measure of modularity of the candidate code 200; an objective measure of maintainability of the code, such as a maintainability index as is known to those skilled in the art; measures of a degree or extent of class coupling in code such as coupling to unique classes through parameters, local variables, return types, method calls, generic or template instantiations, base classes, interface implementations, fields defined on external types, and attribute decoration; measures or metrics relating to code commenting such as an extent, proportion or size of comments; measures or indications of an extent of change constituted by the candidate code 200 such as a relative extent to which the code 252 in the code management repository will be modified by the candidate code 200 if merged; and other metrics as will be apparent to those skilled in the art.

A feature extractor 206 is a hardware, software, firmware or combination component arranged to access the metrics 204 for the candidate code 200 and extract features from the candidate code 200 as a subset of the metrics or combinations of the metrics suitable for classifying the candidate code 200 for the purpose of defect detection. The mechanism of the feature extractor 206 can include a supervised selection technique in which patterns are detected in metrics based on training data including sets of code labelled or associated with known defects such that the metrics most consistently indicative of a known defect can be discerned and extracted as a feature for such the defect. For example, a supervised machine learning classifier can be employed, trained based on such a training data set, to classify metrics according to their association with known defects and, thus, their suitability for informing a process of detecting such known defects. Such metrics are thus extracted as features on which basis the candidate code 200 is processed.

The features of the metrics 204 extracted by the feature extractor 206 are subsequently processed by a classification component 208 including a plurality of disparate classifiers 210. The classifiers are disparate in at least that, inter alia: different classification schemes, approaches and/or methods are employed such as different machine learning algorithms, for example, disparate methods can include a decision tree method, a deep learning method and a random forest method; and different training data is employed to train each disparate classifier. Each classifier 210 is trained based on labelled training data as features of software code including indications of code defects in the training data. In this way, each trained classifier 210 is operable to classify the extracted features for the candidate code 200 to identify an indication of association of the candidate code 200 with one or more code defects. Thus, each of the disparate trained classifiers 210 processes at least a subset of the extracted features to identify a set of the extracted features as indicative of a software code defect in the candidate code 200. Thus, a plurality of feature sets 256 are provided as sets of extracted features indicative of a defect, the sets 256 being generated by the disparate classifiers 210.

A defect identifier component 200 is operable to identify prospective code defects in the candidate code 200 based on the feature sets 256. In particular, intersections between the feature sets 256 constitute features identified by multiple of the disparate classifiers 210 indicative of a code defect. Thus, features identified in intersections between the feature sets 256 have a greater likelihood of indicating a code defect in the candidate code 200. The defect identifier 200 thus identifies intersections between feature sets 256 and, where a number of intersecting sets 256 meets a predetermined number, features in such intersection are identified as indicative of a prospective code defect. The predetermined number of sets 256 can include one or more of, inter alia: a proportion of a number of disparate classifiers 210 used to process the extracted features; at least two; and a predetermined threshold number of sets 256.

A code merger component 200 is provided as a hardware, software, firmware or combination component for selectively merging the candidate code 200 with the code 252 in the code management system based on the prospective code defects identified by the defect identifier 200. For example, the identification of, number of, or type of prospective code defects can preclude the merger of the candidate code 200. For example, the type of a prospective code defect can be defined based on the features constituting the prospective code defect such as by a pre-definition of defect types and associated features. Thus, in this way embodiments of the present disclosure are operable to identify prospective code defects associated with the candidate code 200 and, on which basis, selectively merge the candidate code with the code in the code management system 254.

In one embodiment, the defect identification system 202 further applies a clustering method to the prospective code defects identified by the defect identifier 212. The clustering method is based on features of each prospective code defect to divide the prospective code defects into clusters such that each cluster constitutes a type of code defect. In such an embodiment the selective merging by the code merger 214 is based on the types of code defect indicated by the clusters. For example, the features of each prospective code defect on which basis the prospective defects are clustered can include one or more of, inter alia: attributes of the prospective code defect determined by one or more of the classifiers; and one or more features of the candidate code on which basis the prospective code defect was identified by the classifiers.

In one embodiment, the defect identification system 202 is additionally applied to the code 252 in the code management system 254 both prior to, and after, the selective merging by the code merger 214. Thus, in such embodiment, both before and after the selective merging the defect identification system 202: extracts features of the code 252 in the code management system 254, each feature being based on metrics of the code 252 in the code management system 254; and processes at least a subset of the extracted features from the code 252 by each of the plurality of disparate classifiers 210. In this way, each classifier identifies a set 256 of features indicative of a software code defect in the code 252 in the code management system. Intersections between sets 256 of features identified by the classifiers 210 indicate code defects in the code 252 in the code management system 254. Thus, indications of code defects in the code 252 in the code management system 254 can be generated both before and after the selective merging of the candidate code 200. In such embodiment, the indications of code defects in the code 252 before and after the selective merging are compared to identify code defects introduced by the selective merging of the candidate code 200. Such identification can trigger a remediation process on the code 252 in the code management system 254 such as unmerging the candidate code 200 from the code management system 254.

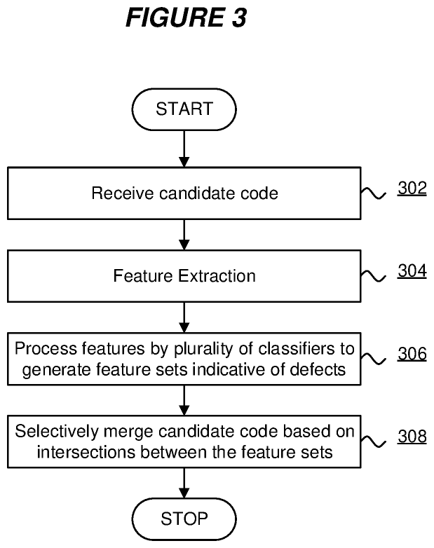

FIG. 3 is a flowchart of a method of updating software code in a code management system in accordance with embodiments of the present disclosure. Initially, at 302, the method receives the candidate code 200 having metrics 204. At 304 the feature extractor 206 extracts features of the candidate code 200 based on the metrics 204. At 306 the method processes the extracted features by the plurality of disparate classifiers 210 to generate feature sets 256 indicative of code defects. At 308 the method selectively merges the candidate code 200 with the code 252 in the code management system 254 based on intersections between the feature sets 254.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the claims.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of updating software code in a code management system, the method comprising:
receiving candidate code for merging with the software code in the code management system;
extracting each of a plurality of features of the candidate code, each feature being based on one or more predetermined metrics of the candidate code;
processing at least a subset of the extracted features by each of a plurality of disparate classifiers, each classifier being trained by a supervised training method to identify one or more software code defects, such that each classifier identifies a set of features as indicative of a software code defect, wherein intersections between a predetermined number of the sets of features identified by the classifiers are indicated as prospective code defects; and
selectively merging the candidate code with the software code in the code management system based on the prospective code defects.

2. The method of claim 1, wherein the predetermined number of sets is one of: a proportion of the number of disparate classifiers used to process the extracted features; at least two; or a predetermined threshold number of sets.

3. The method of claim 1, further comprising applying a clustering method to the prospective code defects based on features of each prospective code defect to divide the prospective code defects into clusters, such that each cluster constitutes a type of code defect, and wherein selectively merging the candidate code with the software code in the code management system is based on the types of code defect indicated by the clusters.

4. The method of claim 3, wherein the features of each prospective code defect includes one or more of: attributes of the prospective code defect determined by one or more of the classifiers; or one or more features of the candidate code on which basis the prospective code defect was identified by the classifiers.

5. A computer system comprising:
a processor and memory storing computer program code for updating software code in a code management system by:
receiving candidate code for merging with the software code in the code management system;
extracting each of a plurality of features of the candidate code, each feature being based on one or more predetermined metrics of the candidate code;
processing at least a subset of the extracted features by each of a plurality of disparate classifiers, each classifier being trained by a supervised training method to identify one or more software code defects, such that each classifier identifies a set of features as indicative of a software code defect, wherein intersections between a predetermined number of the sets of features identified by the classifiers are indicated as prospective code defects; and
selectively merging the candidate code with the software code in the code management system based on the prospective code defects.

6. A non-transitory computer-readable storage medium comprising computer program code to, when loaded into a computer system and executed thereon, cause the computer system to update software code in a code management system by:
receiving candidate code for merging with the software code in the code management system;
extracting each of a plurality of features of the candidate code, each feature being based on one or more predetermined metrics of the candidate code;
processing at least a subset of the extracted features by each of a plurality of disparate classifiers, each classifier being trained by a supervised training method to identify one or more software code defects, such that each classifier identifies a set of features as indicative of a software code defect, wherein intersections between a predetermined number of the sets of features identified by the classifiers are indicated as prospective code defects; and
selectively merging the candidate code with the software code in the code management system based on the prospective code defects.
